(19) United States
(12) Patent Application Publication
(10) Pub. No.: US 2010/0077355 A1
(43) Pub. Date: Mar. 25, 2010

(54) Browsing of Elements in a Display

(76) Inventors: Eran Belinsky, Haifa (IL); Neta Aizenbud-Reshef, Haifa (IL); Michal Jacovi, Rakefet (IL)

Correspondence Address: IBM CORPORATION, T.J. WATSON RESEARCH CENTER, P.O. BOX 218, YORKTOWN HEIGHTS, NY, 10598, US

(21) Appl. No.: 12/236,533

(22) Filed: Sep. 24, 2008

(51) Int. Cl. G06F 3/048

(52) U.S. Cl. 715/835

(57) ABSTRACT

A method and system are provided for browsing the elements in a display. The method includes displaying a first set of elements in a first browse line with the first set of elements ordered in a total or partial order in the first browse line. An input of a selection of an element from the first set of elements is received and the method includes displaying a subsequent set of elements with an association with the selected element. The association of the subsequent set of elements may have no order between the elements, a partial order, or a total order. The elements have content and metadata for determining if they belong to one or more of the sets of elements. An element from the subsequent set of elements can be selected to display a further subsequent set of elements. In this way, browsing can be achieved through groups of associated elements.

### FIELD OF THE INVENTION

This invention relates to the field of browsing of elements in a display. In particular, the invention relates to browsing of elements for improved visual navigation.

### BACKGROUND OF THE INVENTION

It is known to display visual elements by image content similarity. Images are analyzed and sorted for proximal display by image similarity.

It is also know to present displayable elements in sequential order. For example, a sequence of displayable elements may be a timeline of pictures, or a filmstrip of scenes on a video editing tool. For a sequence of elements to be displayed, there is an order between the elements.

Sequential presentation or image content similarity presentation, although useful in their own rights, do not show other relationships between the elements and thus provide limited browsing capability.

### SUMMARY OF THE INVENTION

According to a first aspect of the present invention there is provided a method for browsing elements in a display, comprising: displaying a first set of elements in a first browse line, wherein the first set of elements are ordered in a total or partial order in the first browse line; receiving an input of a selection of an element from the first set of elements; and displaying a subsequent set of elements with an association with the selected element; wherein the elements have content and metadata for determining if they belong to one or more of the sets of elements.

According to a second aspect of the present invention there is provided a computer software product for browsing elements in a display, the product comprising a computer-readable storage medium, storing a computer in which program comprising computer-executable instructions are stored, which instructions, when read executed by a computer, perform the following steps: displaying a first set of elements in a first browse line, wherein the first set of elements are ordered in a total or partial order in the first browse line; receiving an input of a selection of an element from the first set of elements; and displaying a subsequent set of elements with an association with the selected element; wherein the elements have content and metadata for determining if they belong to one or more of the sets of elements.

According to a third aspect of the present invention there is provided a method of providing a service to a customer over a network for browsing elements in a display, the service comprising: displaying a first set of elements in a first browse line, wherein the first set of elements are ordered in a total or partial order in the first browse line; receiving an input of a selection of an element from the first set of elements; and displaying a subsequent set of elements with an association with the selected element; wherein the elements have content and metadata for determining if they belong to one or more of the sets of elements.

According to a fourth aspect of the present invention there is provided a system for browsing elements in a display, the system comprising: a processor; means for analyzing content and metadata of elements stored in a repository to determine if elements belong to a set of elements; means for displaying a first set of elements in a first browse line, wherein the first set of elements are ordered in a total or partial order in the first browse line; user input means for indicating a selection of an element from the first set of elements; and means for displaying a subsequent set of elements with an association with the selected element.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1A is a schematic representation of a display with elements for browsing in a first browse line in accordance with an aspect of the present invention;

FIG. 1B is a schematic representation of a display with second browse lines in accordance with an aspect of the present invention;

FIG. 1C is a schematic representation of a display with second and third browse lines in accordance with an aspect of the present invention;

FIG. 2 is a block diagram of a system of providing a display with element browsing in accordance with an aspect of the present invention;

FIG. 3 is a block diagram of a computer system in which the present invention may be implemented;

FIG. 4 is an example of element browsing in accordance with an aspect of the present invention;

FIG. 5 is an example of second browse lines in the example of FIG. 5 in accordance with an aspect of the present invention; and

FIG. 6 is an example of a first browse line as a lattice in accordance with an aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The described method and system combine a presentation of a sequence of elements in a first order with second order affinities to a selected element.

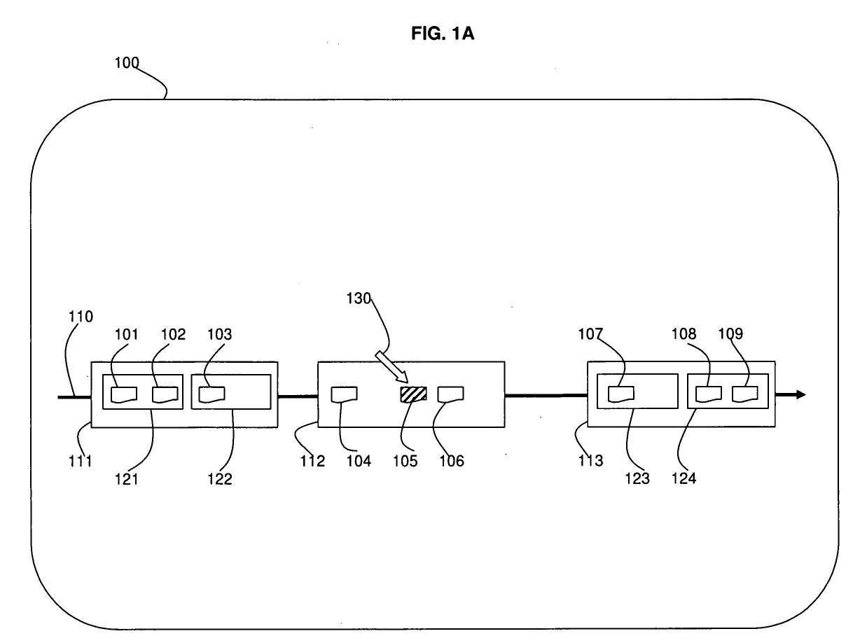

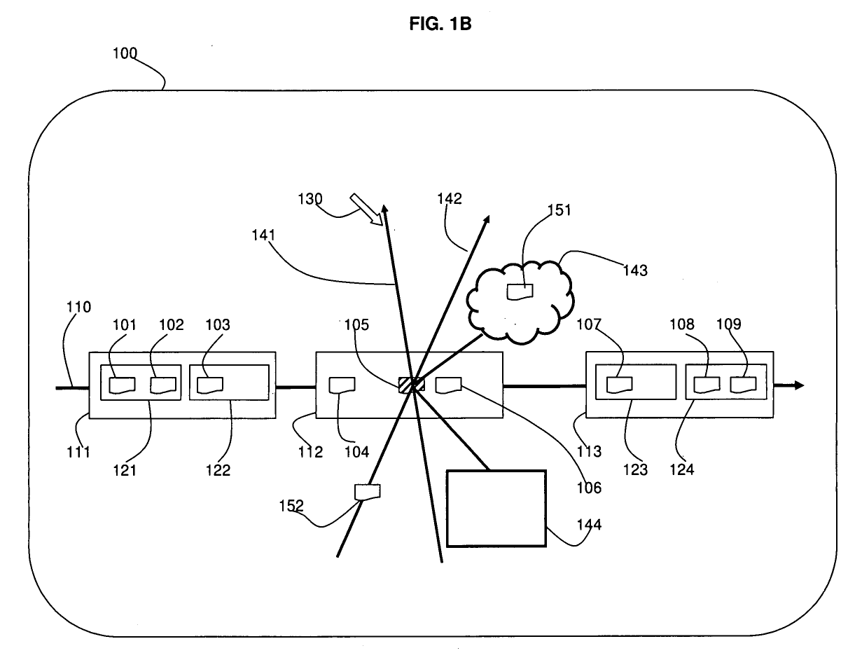

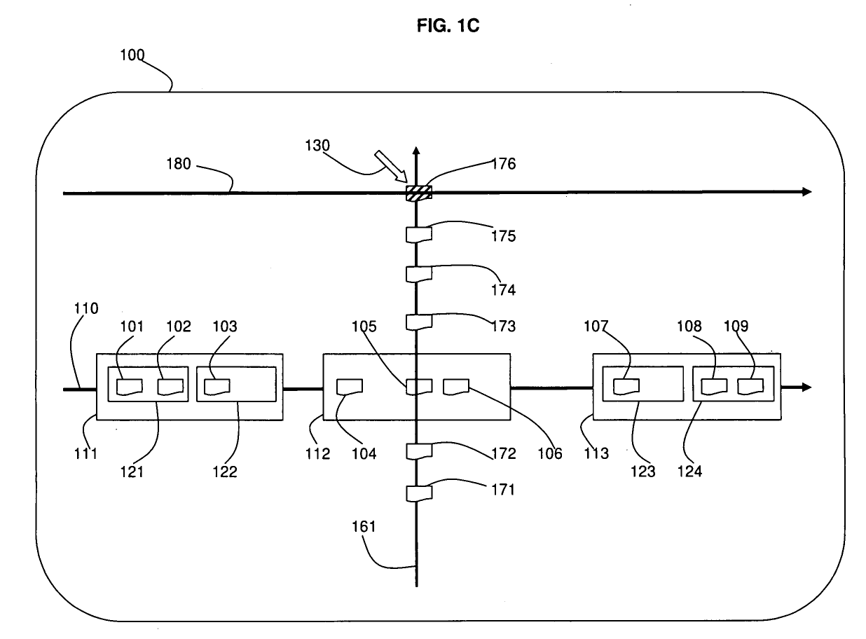

Referring to FIG. 1A, a schematic diagram shows a display 100 of a plurality of elements 101-109 displayed in an arrangement of a first browse line 110 with a first order between the elements 101-109 in the first browse line 110.

The arrangement of the browse line 110 may take various different forms. For example, a horizontal line is shown as the arrangement of the first browse line; however, it will be appreciated that the arrangement of elements in the first browse line may be of another form, such as a vertical line, a diagonal line, a lattice, a curve, or any other suitable arrangement. The term browse line is used broadly to include any form of browse arrangement of multiple elements which may be browsed.

The first order of the elements 101-109 in the first browse line 110 represents a sequence of elements where a total or partial order can be established. In other words, the elements 101-109 can be sorted. Time is a natural example for such a first order. Another example may be element sorting by longitude lines (west on the left, east on the right). Elements as ranked search results may be another example. Element size may be a further example.

In FIG. 1A, the first browse line 110 has a first order shown as time and the first browse line 110 is a horizontal time line with elements 101-109 placed along the line according to their time of creation. The line may have a uniform linear order or a variable scale, for example, with an increased scale where there are several elements, and a reduced scale between times of few elements.

The elements may be grouped and sub-grouped in time ranges along the time line 110. For example, groups 111, 112, 113 may divide the time line 110 into time ranges or time periods. These groups 111, 112, 113 may be equal or may be different, for example, depending on the number of elements in each group. The groups 111, 112, 113 may be divided into sub-groups 121, 122, 123, 124 of more defined time ranges, which in turn may be divided again repeatedly depending on a user's display preference.

Headings may be provided as titles created for timeline elements 101-109 and groups 111-113 and sub-groups 121-124. The headings can be created manually or automatically given a title generation source.

The elements 101-109 are the atomic entities which are not divided. The elements 101-109 may be any form of displayable element. In this example, the elements 101-109 must all have time stamps of time creation by which they can be ordered in the first browse line 110. Examples of displayable elements include image files, video files (for which a start time may be used as the time stamp), audio files (again, using a start time as the time stamp), documents, etc.

An element 101-109 has a content which may be analyzed to obtain details of the element, and an element 101-109 has metadata relating to the element such as the time of creation, the author, the size, the duration, the resolution, settings, etc. The content and/or the metadata of an element 101-109 may be used for ordering it in a first order. In the example of FIG. 1A of a first order of a time line, the metadata of the timestamp of the element's creation is used.

An element 105 may be selected by a user. The selection may be by using a pointer device represented by a pointer symbol 130 in the display 100. The described method of display provides a second browse line for a selected element 105. Subsequent browse lines for further selected elements are also provided as described further below.

A second browse line provides a further group of elements (of which the selected element is one) where there is some form of association between the elements in the group. This association may be a total order, a partial order, or no order at all. The association is determined by the content and metadata of elements which is analyzed.

There are multiple ways that elements may relate to other elements. For example, they can share a textual term, a location, a person mentioned, a time of occurrence, etc.

In an example in which the elements are images, words that appear within the images can be extracted, as well as other means of similarity such as where the picture was taken. This could be expanded to terms that are close lexicographically (“run” vs. “running”) or semantically (“run” vs. “dash”), locations close by (St. James Park vs. Hyde Park) and alternative spelling of names (“James T. Kirk” vs. “Jim Kirk”). The elements may even share properties: in the case of images, these may be visual properties such as same background color, or same background pattern (as for slides from the same presentation).

Given an element and a set of related elements, there may not necessarily be a function that allows the sorting of all the related elements. For example, it is not possible to compare location affinity to person affinity as it is subjective, if it exists at all.

In one embodiment, for the second browse line for associated elements, all the elements that have the association are grouped and some form of sorting that may or may not represent a total or partial order is provided. Different proximity definitions may define the layout of items in the display which may be accurate or fuzzy.

In an alternative embodiment, no form of sorting may be provided and visualization may be used to show the association in an unordered group. For example, the association may be represented as a circle or a cloud, or as rays from an element or connecting all the elements, or in a non-ordered line.

Referring to FIG. 1B, the content of the display 100 of FIG. 1A is extended. FIG. 1A showed a plurality of elements 101-109 displayed in an arrangement with a first browse line 110 of a first order in the form of a time line.

In FIG. 1B, an element 105 is selected and a choice of second browse lines 141-144 of second associations is displayed. In one embodiment, before a second browse line 141-144 is selected, the second browse lines may be displayed in a reduced form. When a second browse line is selected 141-144, the selected second browse line is expanded to its full form showing all its elements.

The reduced form of the second browse lines 141-144 may be shown as lines 141, 142 radiating from the selected element 105, or as an associated cloud 143, or window 144.

The reduced form of the second browse lines 141-144 of second associations can include any number of browse lines (for example, based on different association relations) that are displayed as a fan of lines or overlapping clouds or windows.

The reduced form of second browse lines 141-144 when all displayed for selection may show none or a selected number of their element members 151-152 in order to indicate the second association.

The reduced form of the second browse lines 141-144 can have labels or other visual identifying means of the second association. A tooltip interface element may alternatively or additionally be provided in which the user hovers the cursor over a reduced form of second browse line 141-144, without clicking it, and a small “hover box” appears with supplementary information regarding the association of the browse line being hovered over.

The reduced form of the second browse lines 141-144 may include visual cues (colors, labels, etc.) that explain the nature of the associative proximity of the selected element to the other elements in the second association.

The reduced form of the second browse lines 141-144 may be coded according to second associations of the same type. For example, if elements 101-109 are images, the second associations could be various proximity reasons: a word appearing in the images, a person in the images, the fact that the images were taken at the same place, and so on. This can be visualized in order to help the user understand, with a glance, the nature of the proximity. For example, all connectors for associations of people in images may be in green, all word connections in red, and location connections in blue.

Selecting one of the reduced forms of the second order browse lines 141-144 can be carried out by selecting the line or area or a displayed element on one of the reduced forms of second browse lines 141-144, for example, by using a pointer 130. The selection of one of the second browse lines 141-144 will discard the rest of the reduced forms of second browse lines, leaving the selected second browse line 141.

Referring to FIG. 1C, one of the reduced forms of second browse lines 141-144 is chosen, say second browse line 141, and expanded to show its full form 161. For example, the selected second association may be for images taken in the same location as the selected element 105.

The expanded second browse line 161 is shown in FIG. 1C as a vertical line of all the elements 171-176 in the association. The elements may be sorted by some order or randomly displayed.

FIG. 1C shows that an element 176 in the second browse line 161 may be selected, for example, by use of a pointer 130. Subsequent displays of reduced forms of third browse lines 180 may be displayed as in FIG. 1B. The third browse lines may represent third associations which may be a total order, a partial order, or no order, as in the second associations.

The third browse line 161 may be a different section of the first browse line (for example, the timeline of FIG. 1A). For example, a user may click on a first selected element in the first browse line, click on a related element on the second browse line, and then see the third browse line which is actually the same as the first browse line, but focused on the second selected element, which was taken a year before the first selected element.

Further subsequent browse lines for subsequent associations with selected elements can be displayed indefinitely, providing an ongoing method of browsing through elements' associations.

In one embodiment, odd-numbered browse lines have some order (total or partial), whereas the even-numbered browse lines do not require an order. A cloud or window can be used for the second browse line (and the fourth, sixth, etc.), in the case where there is no order.

A fisheye view may be used to give an element in the user's focus a larger screen space as the user points to an element while not removing the marginal items from the display but rather just minimizing their size.

An alternative to the fisheye view may be to keep a layout of horizontal and vertical lines. Another alternative would be to open a new window, or a new layer, that expands the element in focus.

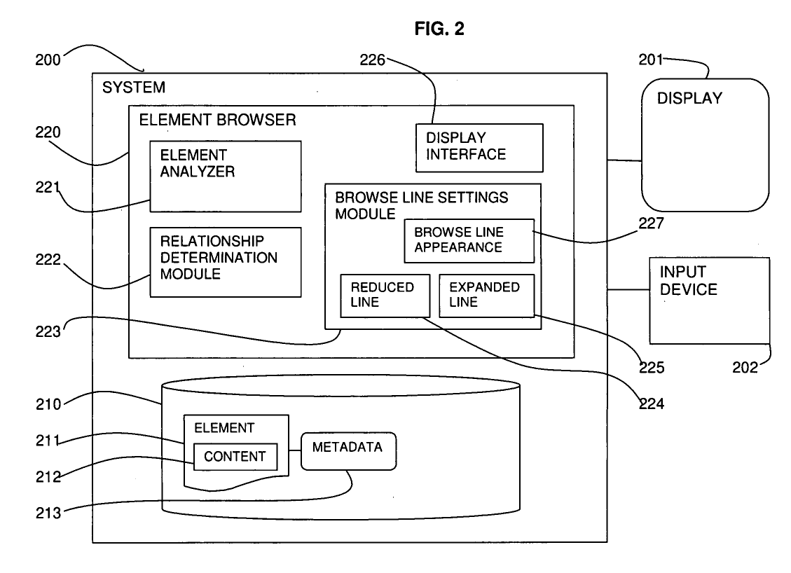

Referring to FIG. 2, a block diagram shows a system 200 for display of elements. The system 200 includes a repository 210 of elements 211, with each element 211 including content 212 and metadata 213. An element browser 220 is provided including an element analyzer 221, an element relationship determining module 222, a browse line settings module 223, and a display interface 226. The browse line settings module 223 includes means for inputting settings for the browse line appearance 227 such as a choice of a line, a collection of rays, a cloud, a window, or any other visualization. The browse line settings module 223 also includes means for inputting settings for reduced browse lines 224 and expanded browse lines 225. The display interface 226 is a means for displaying the elements and browse lines in reduced and expanded forms.

The system 200 includes a display 201 for viewing by a user and an input means 202 for selection of elements on the display 201 and for input of settings in the element browser 220 by a user.

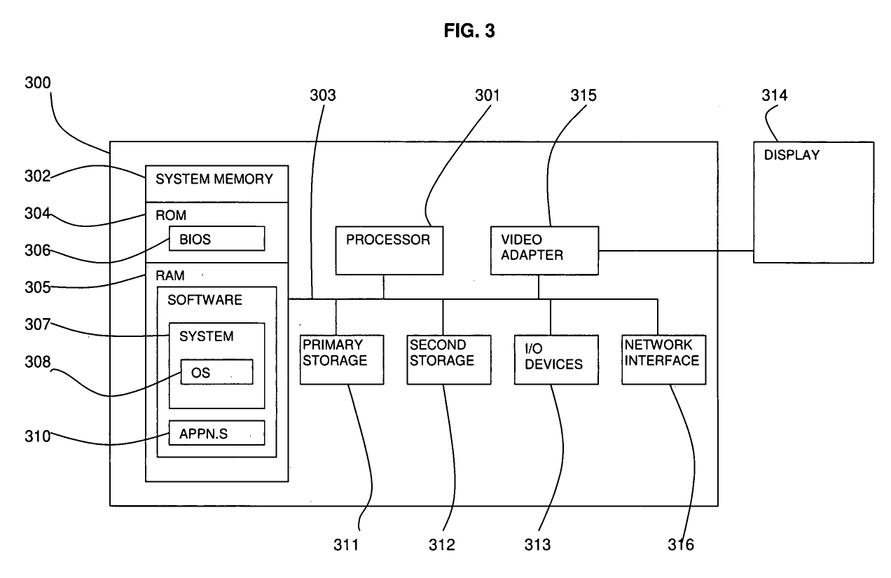

Referring to FIG. 3, an exemplary system for implementing the element display and browser includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

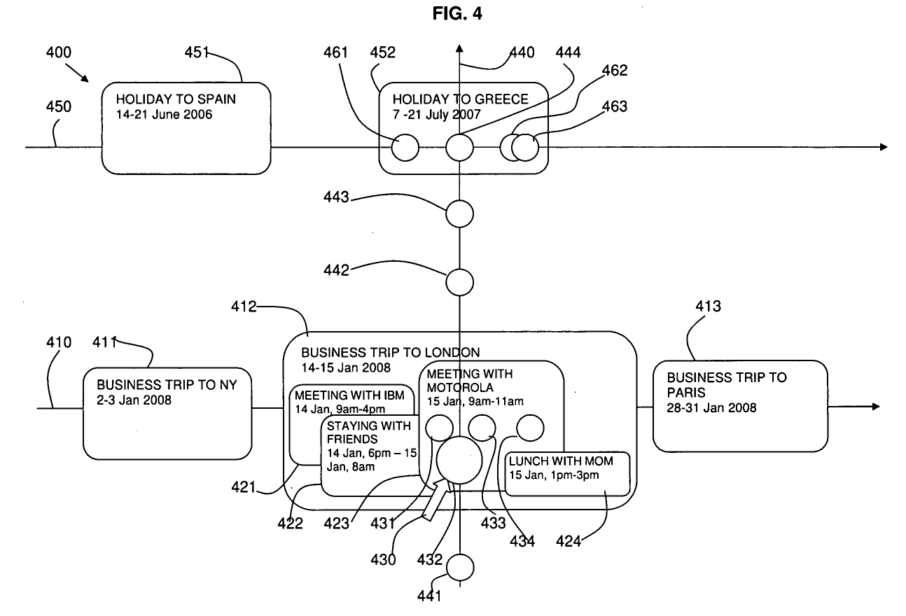

Working examples are given with reference to FIGS. 4 5 and 6.

Referring to FIG. 4, an element display and browsing interface 400 is shown with a first browse line 410 in the form of a horizontal time line. There are three top-level events 411, 412, 413 on the first browse line 410: a business trip to New York 411 that took place between January 2 and January 3 (title: “Business Trip to NY”), a business trip to London 412 that took place between January 14 and January 15 (title: “Business Trip to London”), and a business trip to Paris 413 that took place between January 28 and January 31 (title: “Business Trip to Paris”). The first browse line 410 in the form of the timeline has the events 411, 412, 413 in the time order of “Business Trip to NY”, “Business Trip to London”, “Business Trip to Paris”.

The user focused on the event 412 of “Business Trip to London” which is enlarged. Within the event 412 of the trip to London, there is a secondary breakdown of events into four sub-events 421-424: “Meeting with IBM” 421 (Jan. 14, 9 am-4 pm), “Staying with friends” 422 (Jan. 14, 6pm-Jan. 15, 8am), “Meeting with Motorola” 423 (January 15, 9 am-11 am), and “Lunch with mom” 424 (Jan. 15, 1pm-3pm).

Within the “Meeting with Motorola” sub-event 423 there are four elements 431-434 in the form of photographs: one of a person 432, one of the person's business card 431, one of a page of a proposed contract 433, and one of the whiteboard at the end of the meeting 434. These photographs all took place within the timeframe of the meeting, according to the order described, and have timestamps. There is no overlapping between events or sub-events, although this may occur can be handled by using the start time of each element for sorting purposes.

The user selects the element in the form of the photograph of a person 432 by pointing a pointer 430 at the element 432 or clicking on it. The photograph of the element 432 is shown as a fisheye view to expand it as the user hovers over the element 432 or selects it by clicking.

A second browse line 440 is shown as an orthogonal line of elements 441-444 which are associated with the selected element of the photograph of a person 432. The elements 441-444 may be for example other photographs of the same person.

Selecting one of the photographs 444 of the same person 441-444 in the second browse line 440 displays a third browse line 450 focused on the selected photograph 444. In this example, the third browse line 450 is a time line of events 451-452 including elements within each event.

In this example, the events 451-452 shown in the third browse line 450 may be holidays, such as a “Holiday to Spain” 451 (14-21 Jun. 2006) and a “Holiday to Greece” 452 (7-21 Jul. 2007). The selected photograph 444 may be one of a group of photographs 461, 444, 462, 463 in the event of the “Holiday to Greece” 452.

By browsing a display in this way, the user has navigated from a recent business trip to find a holiday photograph of a person who was in the recent meeting with the user.

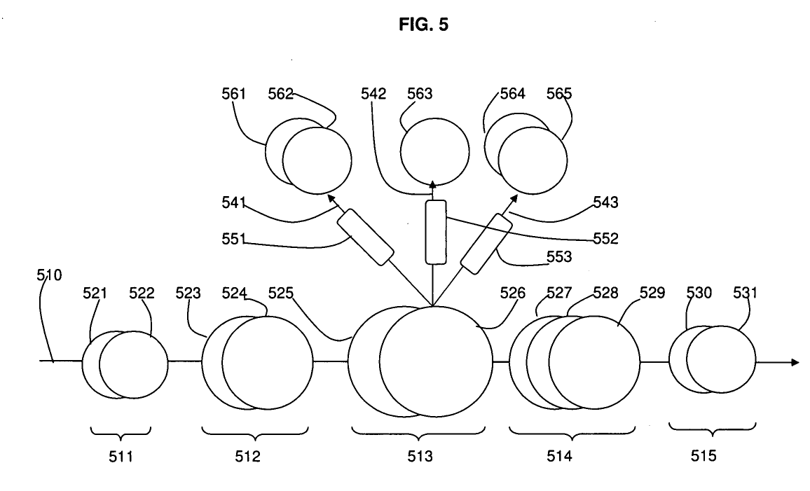

Referring to FIG. 5, an alternative form of first browse line 510 is shown in the form of a time line with elements grouped in overlapping clusters 511-515 with elements 521-532 in each cluster 511-515 overlapping whilst in the time order. In this embodiment, there is no event display label within which elements are grouped.

An element 526 in one of the clusters 513 is selected and three optional second browse lines 541-543 are shown. The optional second browse lines 541-543 are shown in a reduced form with a limited selection of elements in each second browse line 541-543 shown. Each of the reduced forms of second browse line 541-543 has a label 551-553.

In the example shown, a first reduced second browse line 541 is for the associated group of other elements in the form of other photographs of the same person “Tal” shown in the selected element 526 of the first browse line 510. Two other elements 561, 562 are shown in the reduced form of the second browse line 541 and the label “Tal” 551 is provided indicating the association is all photographs showing the person “Tal”.

A second reduced second browse line 542 is for the associated group of other elements in the form of other photographs taken at the same location of “San Francisco” as the selected element 526 of the first browse line 510. One other elements 563 is shown in the reduced form of the second browse line 542 and the label “San Francisco” 552 is provided indicating the association is all photographs taken in the location of San Francisco.

A third reduced second browse line 543 is for the associated group of other elements in the form of other photographs including the word or name “IBM” provided in a name of the element for the selected element 526 of the first browse line 510. Two other elements 564, 565 are shown in the reduced form of the second browse line 543 and the label “IBM” 553 is provided indicating the association is all photographs including the name “IBM”.

If the first reduced second browse line 541 is selected by a user, an expanded browse line will be displayed from which a further element can be selected.

In another worked example, search results may be displayed on a first browse line on the horizontal axis, sorted by search rank. For each search result, a second browse line in the form of a vertical line ordered by time of the things that occurred before and after the selected search result can be displayed.

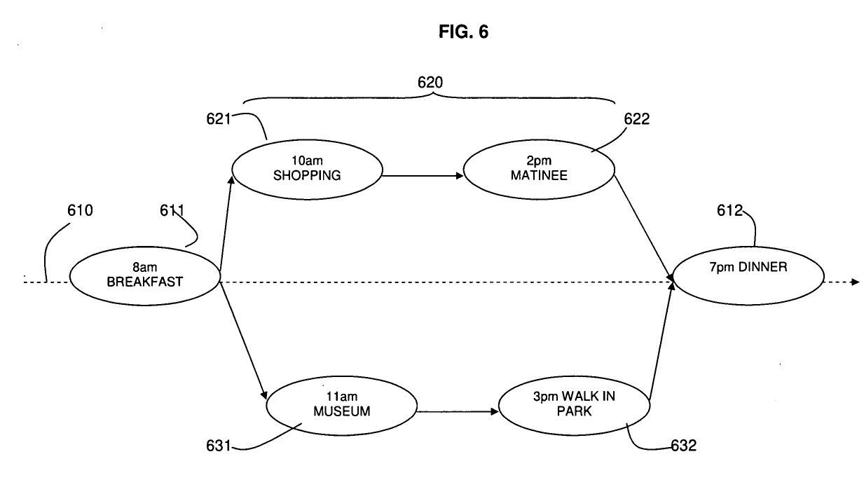

Referring to FIG. 6, an example of a first browse line 610 as a lattice is shown for a first set of elements with a partial order. In the shown example, two people go on a trip together. Some of their activities are carried out together and some are carried out separately.

The first browse line 610 is a lattice 620 with the activities carried out by both people shown on the time line, and individual activities shown in a lattice 620. For example, they have breakfast together at 8am 611, and then split to their separate activities. One of them goes shopping 621 and then to a matinee 622, while the other goes to a museum 631 and then a walk in the park 632. They reconvene for dinner at 7pm 612.

The separate activities may be ordered on a single timeline as a sequence, alternatively they can be visualized it as a lattice 620, as shown in FIG. 6. The lattice visualization stresses that this is one shared trip of the couple on a timeline, that branches in the middle when they separated for a period of time, but the threads join eventually (and may branch again later, and so on). A lattice can be used in the described method for any sets of elements with a partial order.

Constructing a timeline/sequence view of elements is known, implemented in many applications. The described method and system expand the use of time lines and other associations to provide enhanced browsing of elements. When a user clicks on an element A in a sequence, an orthogonal associative browse line is displayed. The order of elements on this line can be arbitrary or based on some affinity metric, so that “closer” items (according to the metric) are located in closer proximity to element A. If the user clicks on one element B on the orthogonal browse line, a secondary sequence/timeline view or other affinity metric of the elements is displayed, focused at element B.

An element display and browser may be provided as a service to a customer over a network.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The invention can take the form of a computer program product accessible from a computer-usable or computer-readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read only memory (ROM), a rigid magnetic disk and an optical disk. Current examples of optical disks include compact disk read only memory (CD-ROM), compact disk read/write (CD-R/W), and DVD.

Improvements and modifications can be made to the foregoing without departing from the scope of the present invention.

We claim:

1. A method for browsing elements in a display, comprising:
displaying a first set of elements in a first browse line, wherein the first set of elements are ordered in a total or partial order in the first browse line;
receiving an input of a selection of an element from the first set of elements; and
displaying a subsequent set of elements with an association with the selected element; wherein the elements have content and metadata for determining if they belong to one or more of the sets of elements.

2. The method as claimed in claim 1, wherein the association of the subsequent set of elements has one of the group of: no order between the elements, a partial order, or a total order.

3. The method as claimed in claim 1, wherein displaying a subsequent set of elements displays the elements in a second browse line provided at an angle to the first browse line.

4. The method as claimed in claim 3, wherein a plurality of second browse lines for a plurality of subsequent sets of elements each with a different association with the selected element are displayed in second browse lines radiating from the selected element.

5. The method as claimed in claim 4, wherein the plurality of second browse lines are displayed in a reduced form providing an indication of the association.

6. The method as claimed in claim 5, wherein the indication of the association includes one of the group of: a label, a tooltip, one of the elements in the association, a colour indicating a predefined association.

7. The method as claimed in claim 4, including receiving an input of a selection of one of the plurality of second browse lines for display and displaying the selected second browse line in an expanded form to include all the elements in the subsequent set.

8. The method as claimed in claim 7, including:
receiving an input of a selection of one of the elements from the subsequent set of elements; and
displaying a further subsequent set of elements with an association with the selected element.

9. The method as claimed in claim 1, wherein a browse line includes displaying groups of elements within the set to form sub-sets and the elements within a sub-set are displayed when the group is selected.

10. The method as claimed in claim 1, wherein odd-numbered sets of elements displayed in browse lines have partial or total order and even-numbered sets of elements have total order, partial order or no order.

11. A computer software product for browsing elements in a display, the product comprising a computer-readable storage medium, storing a computer in which program comprising computer-executable instructions are stored, which instructions, when read executed by a computer, perform the following steps:
displaying a first set of elements in a first browse line, wherein the first set of elements are ordered in a total or partial order in the first browse line;
receiving an input of a selection of an element from the first set of elements; and
displaying a subsequent set of elements with an association with the selected element; wherein the elements have content and metadata for determining if they belong to one or more of the sets of elements.

12. A method of providing a service to a customer over a network for browsing elements in a display, the service comprising:
displaying a first set of elements in a first browse line, wherein the first set of elements are ordered in a total or partial order in the first browse line;
receiving an input of a selection of an element from the first set of elements; and
displaying a subsequent set of elements with an association with the selected element; wherein the elements have content and metadata for determining if they belong to one or more of the sets of elements.

13. A system for browsing elements in a display, the system comprising:
a processor;
means for analyzing content and metadata of elements stored in a repository to determine if elements belong to a set of elements;
means for displaying a first set of elements in a first browse line, wherein the first set of elements are ordered in a total or partial order in the first browse line;
user input means for indicating a selection of an element from the first set of elements; and
means for displaying a subsequent set of elements with an association with the selected element.

14. The system as claimed in claim 13, wherein the means for displaying a subsequent set of elements displays the elements in a second browse line provided at an angle to the first browse line.

15. The system as claimed in claim 14, including a means for displaying a plurality of second browse lines for a plurality of subsequent sets of elements each with a different association with the selected element in second browse lines radiating from the selected element.

16. The system as claimed in claim 15, wherein the means for displaying the plurality of second browse lines in a reduced form provides an indication of the association.

17. The system as claimed in claim 16, wherein the indication of the association includes one of the group of: a label, a tooltip, one of the elements in the association, a colour indicating a predefined association.

18. The system as claimed in claim 15, wherein the user input means is used for selection of one of the plurality of second browse lines for display and the system includes means displaying the selected second browse line in an expanded form to include all the elements in the subsequent set.

19. The system as claimed in claim 13, wherein means for displaying a browse line includes displaying groups of elements within the set to form sub-sets and the elements within a sub-set are displayed when the group is selected.

20. The system as claimed in claim 13, including a user settings input means for setting the display form of the browse lines.
